(19) United States
(12) Patent Application Publication
(10) Pub. No.: US 2018/0078889 A1
(43) Pub. Date: Mar. 22, 2018

(54) METHOD FOR THE QUALITY IMPROVEMENT OF A GAS-PERMEABLE OBJECT REMOVED FROM AN EXHAUST GAS SYSTEM OF AN INTERNAL COMBUSTION ENGINE AND AN APPARATUS THEREFOR

(71) Applicant: HIRTENBERGER AKTIENGESELLSCHAFT, Hirtenberg (AT)

(72) Inventor: Hanspeter MAYER, Allerheiligen (AT)

(73) Assignee: HIRTENBERGER AKTIENGESELLSCHAFT, Hirtenberg (AT)

(21) Appl. No.: 15/694,044

(22) Filed: Sep. 1, 2017

(30) Foreign Application Priority Data
Sep. 16, 2016 (EP) 16189194.0

(51) Int. Cl. B01D 41/04; B08B 5/02; B08B 7/00; B08B 13/00; B01D 46/00; B01D 53/96; B01J 38/02

(52) U.S. Cl. CPC B01D 41/04; B08B 5/02; B08B 7/0071; F01N 3/021; B01D 46/0086; B01D 53/96; B01J 38/02; B08B 13/00

(57) ABSTRACT

The invention relates to a method for the quality improvement of a gas-permeable object, such as a filter or catalyst, removed from an exhaust gas system of an internal combustion engine. To attain a cost-effectively realizable method, it is provided according to the invention that, in an automated process, a condition of the object is measured, after which a quality improvement is carried out, after which a condition of the object is measured again.

Furthermore, the invention relates to an apparatus for the diagnosing and quality improvement of a gas-permeable object, such as a filter or a catalyst, removed from an exhaust gas system of an internal combustion engine.

### CROSS-REFERENCE TO RELATED APPLICATIONS

The present application claims priority under 35 U.S.C. § 119(a) of European Patent Application No. EP 161 89 194.0 filed Sep. 16, 2016, the disclosure of which is expressly incorporated by reference herein in its entirety.

### BACKGROUND OF THE INVENTION

### 1. Field of the Invention

The invention relates to a method for the quality improvement of a gas-permeable object, such as a filter or catalyst, removed from an exhaust gas system of an internal combustion engine.

Furthermore, the invention relates to an apparatus for the quality improvement of a gas-permeable object, such as a filter or a catalyst, removed from an exhaust gas system of an internal combustion engine.

### 2. Discussion of Background Information

From the prior art, different methods and apparatuses have become known for the quality improvement of, in particular for cleaning, a gas-permeable object, such as a filter or a catalyst, in particular a diesel particulate filter, removed from an exhaust gas system of an internal combustion engine, specifically from the exhaust gas system of a motor vehicle. A need for methods and apparatuses of this type is increasing due to lower limits for exhaust gases from motor vehicles, in particular from diesel-powered motor vehicles, and because of high costs for components of exhaust gas cleaning systems.

Methods and apparatuses from the prior art for the quality improvement of, in particular for cleaning, objects of this type have the disadvantage that they can only be implemented with significant effort. Trained technical personnel are thereby often required to carry out the method, as a result of which considerable costs are incurred.

### SUMMARY OF THE EMBODIMENTS

This is addressed by the invention. The object of the invention is to specify a method of the type named at the outset which can also be implemented in a cost-effective manner with untrained personnel.

In addition, an apparatus of the type named at the outset for carrying out such a method is to be specified, which apparatus can be produced in a simple and economical manner.

According to the invention, the first object is attained with a method of the type named at the outset if, in an automated process, a condition of the object is measured, after which a quality improvement is carried out, after which a condition of the object is measured again.

Within the scope of the invention, it was discovered that the method can be performed in a particularly cost-effective manner if, in a fully automated process, a condition or quality of the object is measured, after which a quality improvement, in particular a cleaning, is carried out, after which another condition measurement is conducted. The method can thus also be implemented with suitable process-reliability by untrained personnel, for example in motor vehicle repair shops. A manual intervention is thus only necessary to transfer an object with diminished quality, for example a particle filter contaminated by ash deposits, to a corresponding apparatus for performing the method, and to subsequently once again remove the object with improved quality, or the cleaned object.

However, a device for the automated loading of the apparatus can also be provided, so that multiple objects can be cleaned consecutively in an automated manner, or a quality of multiple objects can be improved without manual intervention. Thus, multiple systems can also be operated in an interlinked manner in order to clean a large number of objects or to improve a quality of the same.

A quality of the objects can be improved in particular by cleaning. Alternatively, as part of the quality improvement, it can also be provided that a catalytic reactivity of an aged filter can be activated or improved. A quality of the object is thus improved without cleaning. For an object such as a filter, a quality can be defined using a particle retention capacity, a catalytic reactivity, a conversion rate, a level of cleanliness, or a combination of these types of measurable parameters.

A change in the condition of the object during a cleaning or during a quality improvement can also be ascertained by measuring a condition before and after the cleaning or quality improvement and used for a control of the process. For example, an improvement in a quality or a cleanliness condition of the object that cannot be attained by means of a cleaning can be used for an automatic classification of the object as unusable or not reprocessable.

It is beneficial if, based on a result of the condition measurement, a cleaning strategy is selected in an automated manner, and if a cleaning is then performed according to the cleaning strategy for the quality improvement. It can thus be ensured that the object is cleaned or reprocessed in a highly effective manner, since a cleaning can be performed that is matched to a specific condition, for example a soiling that has been detected.

It is advantageous if a quality improvement, in particular a cleaning, is carried out until a stopping criterion is reached, such as a desired quality or cleanliness condition, or until a cleaning progress falls below a threshold. By defining a corresponding stopping criterion, it can thus be ensured that, on the one hand, a cleaning no longer takes place when a desired cleanliness condition is reached or if no further cleaning progress is discernible despite continued cleaning. A cleaning progress is determined by comparing results from condition measurements that are conducted before and after a cleaning.

A measurement of a condition, or a condition or quality measurement, can for example occur in an automated manner by means of an optical measurement with a camera and automated evaluation of a camera image, a differential pressure test, or a measurement of a catalytic reactivity or a measurement of a particle retention capacity. With regard to methods for measuring a condition or a quality of an object such as a filter or a catalyst, the documents EP 2 884 065 A1, EP 2 884 066 A1, EP 2 884 067 A1 and WO 2015/086597 A2 are cited, the disclosures of which are hereby incorporated by way of reference. In order to be able to localize contamination or damage with pinpoint accuracy, the object can also be analyzed using X-rays or the like.

In principle, the cleaning or a functional or quality improvement such as an activation or improvement of a catalytic reactivity can take place in a wide variety of ways. It has proven particularly beneficial if the cleaning is carried out with a positively pressured medium and/or a hot medium, in particular a hot fluid, particularly a hot gas. Furthermore, the cleaning can take place using a medium at a high velocity, for example using air at supersonic speed.

To achieve a particularly high degree of automation with a simultaneously simple practicability of the method, it is beneficial if the object is transported during the method by a workpiece carrier that is gas-permeable. An object that is to be cleaned, such as a particle filter of a motor vehicle, typically has a honeycomb structure or the like, with two opposing faces for an entry and exit of exhaust gas. Through the use of a gas-permeable workpiece carrier, it is ensured that a gas applied at one face for cleaning or for a quality assessment can pass through the object and exit through the object and the workpiece carrier again at the opposing face. Furthermore, with the use of a gas-permeable workpiece carrier, a cleaning medium such as a hot gas, a gas at high velocity or compressed air can also be applied to the object through the workpiece carrier to clean the object, or to test and/or improve a quality of the object, from two sides simultaneously or alternatingly.

For the uniform application of a cleaning medium to a side on which the object is connected to the workpiece carrier, it has proven effective that the workpiece carrier comprise a diffuser. The diffuser can also be constituted by a diffuser insert. Typically, the object is arranged upright on the workpiece carrier and a cleaning medium can thus also be applied from below via the diffuser to the face of the object that is positioned on the workpiece carrier, or said face can be evenly cleaned or quality-tested with a hot gas. For this purpose, it is particularly beneficial if, at an end facing the object, a cross section of the diffuser matches a cross section of the object on the corresponding face. To achieve a simple adaptability of the workpiece carrier to a wide variety of objects, the diffuser can also be formed by an exchangeable diffuser insert that is connected to the workpiece carrier. The diffuser insert thus forms an adapter for connecting different objects to the workpiece carrier. Furthermore, as an alternative or in addition to the diffuser insert, replaceable measuring nozzles, laser sensors, cameras and the like can also be detachably connected to the workpiece carrier for a cleaning and/or quality assessment.

Preferably, the object is cleaned with a hot gas that is applied through a diffuser, typically in a hot gas cell. It has thereby proven beneficial that an axially and/or radially adjustable diffuser be inserted which is adapted to a geometry of the object prior to an application of the hot gas. The diffuser can also be embodied such that it is obliquely adjustable. An adaptation normally takes place in an automated manner, after a geometry of the object has been detected. A detection of a geometry of the object typically also occurs in an automated measuring procedure, for example during an entry of the object into an apparatus for performing the method. Any interfering object contours present are thereby preferably also detected in an automated manner. This can be interfering contours in an axial or radial direction, such as brackets, flanges, sensors, pipe sections and the like. Thus, on the one hand, the method is easily adapted to different objects with different diameters and, on the other hand, an effective regeneration is ensured by a uniform application of a hot gas to the object with low energy consumption. By monitoring the regeneration, an uncontrollable exothermic reaction is thereby avoided which could lead to a production of smoke or to a fire.

A particularly efficient cleaning of the object is possible in a simple manner if a hot gas is applied to two opposing faces of the object from different directions. The hot gas can thereby be applied simultaneously or alternatingly to a top side and a bottom side of the object. In the case of an alternating application of a hot gas, a better penetration or a larger heated filter volume can be achieved with an unchanging heating output than in the case of application from only one side. In this manner, the object can be fully heated or thermally cleaned and/or a quality of the object improved with a reduced energy requirement. The method is thus also particularly well suited to being carried out in motor vehicle repair shops and the like, in which only a small amount of power is available for performing the method. By means of a thermal cleaning, urea crystals in particular are removed in SCR catalysts, sulfur and phosphorus poisoning of catalytic centers in corresponding filters is reversed and oil residues are burned, so that a functioning of the object is improved.

Typically, a diffuser with a variable geometry for adapting to objects with different sizes and/or different diameters is arranged stationarily at the head end in an apparatus for performing the method, via which diffuser a hot gas can be applied to the object from above for cleaning. With an exchangeability of a diffuser insert arranged at the bottom end in a workpiece carrier and a variable geometry of the head-end stationary diffuser, an application of a hot gas to the object both from above and also from below is thus ensured, wherein at the same time an adaptability to objects with different diameters is provided.

It has proven effective that a cleaning takes place with a pressurized fluid, in particular a gas, preferably air, typically at a pressure of 1 bar to 50 bar, preferably less than 10 bar. The gas can thereby essentially be applied both at a subsonic and also a supersonic speed, wherein a pressure or a pressure energy can be completely converted into a velocity of the gas or a velocity energy, respectively. Thus, a gas with a velocity or a gas with a low static and high dynamic pressure is also understood as being a pressurized gas. A cleaning of this type is also referred to as mechanical cleaning and is normally carried out before a cleaning of the object with a hot gas, wherein this depends on a selected cleaning strategy. Here, a sequence of individual cleaning steps, such as a mechanical cleaning or a thermal cleaning, and the selection of individual parameters for the cleaning performed, such as a temperature of an applied medium or a pressure of compressed air in a mechanical cleaning, are referred to as a cleaning strategy. An automated selection of a cleaning strategy usually takes place based on a detected cleanliness condition and/or a detected structural condition of the object.

It is beneficial if the pressurized gas is applied at a velocity of 1.0 to 3 times the speed of sound. Typically, the object is cleaned with air that is applied at a velocity of 300 m/s to 1000 m/s, in particular approximately 1.9 times the speed of sound.

It has proven particularly beneficial if the gas is applied through a nozzle, wherein a spray angle is 1° to 45°, preferably 10° to 15°. In this manner, a velocity of the air also remains high enough on impact of the same with the object that a particularly suitable cleaning effect and quality improvement are achieved. In addition, at a corresponding spray angle, there results a high pressure gradient perpendicular to a direction of flow, which gradient is also beneficial for a cleaning of particle filters. Alternatively or additionally, the gas can also be applied through a gas line with a corresponding nozzle and a diffuser end.

In principle, a gas can, for example, be applied through a single nozzle for cleaning. It is advantageous if, for the cleaning, a gas is applied simultaneously or alternatingly to a face of the object through multiple, in particular two to five, nozzles. A particularly rapid and, at the same time, efficient cleaning with compressed air is thus possible. Alternatively, the cleaning can also take place with a gas line having a diffuser end with a constant or pulsating gas flow.

A particularly effective cleaning is possible with a low expenditure of energy if the gas is applied using time-variable pressure or in pulses, preferably at a frequency of 0.1 Hz to 100 Hz, in particular 1 Hz to 10 Hz. In this manner, a very effective cleaning can occur. As an alternative to a gas such as steam, air or the like, a different fluid, for example a cleaning liquid, can in principle also be applied with pulsating-alternating or time-variable pressure in order to clean the object. A pulse frequency can essentially be in both a supersonic and also a subsonic range.

It has proven beneficial that multiple, in particular two to five, nozzles be used and pressure pulses be applied through the individual nozzles in a time-staggered manner. Thus, by means of a time-staggered actuation of individual nozzles that are preferably aimed at the same region of the object and typically have a parallel orientation, a correspondingly higher pulse frequency on the object can be achieved. In this manner, a very effective cleaning can be ensured. At the same time, the cleaning is thus also possible through multiple nozzles with a low compressor power for supplying compressed air, so that the method can, for example, also be easily implemented in motor vehicle repair shops, which have only a limited supply of energy at their disposal. It has been shown that, in a method wherein individual nozzles are actuated in alternating pulses, a better cleaning effect can be achieved than with a continuous flow from one nozzle at the same compressor power. As an alternative to a compressor, a gas moved at a desired velocity can of course also be supplied by means of a blower or a combustion reaction or with a gas generator.

In addition, aside from a particularly effective cleaning, a very suitable removal of contamination from cell walls of a filter can also be achieved in the case of a flow from multiple nozzles, wherein the individual nozzles are actuated or opened and closed at different pulse frequencies, due to beat effects and pressure wave interferences. Thus, in a superposition of pressure pulses that result from an actuation frequency of the nozzles of 1 Hz to 10 Hz, high-frequency concentrated pulses with frequencies of approximately 10 Hz to 1000 Hz can be achieved through pressure reflections.

Advantageously, two nozzles aligned in parallel are aimed at an object that is to be cleaned and are actuated in alternating pulses so that, for example, 10 compressed air pulses are applied to the object at supersonic speed from a first nozzle, after which 10 pulses are applied to the object at supersonic speed from the second nozzle. It has been shown that significant velocity and pressure differences that thereby occur between streamlines of the two nozzles as a result of a shearing effect and velocity differences of two parallel gas flows lead to an increase in a cleaning effect, as well as to a spatial pulsation field or spatial pressure waves. A static pressure is thus at a maximum when an air velocity is at a minimum or when a nozzle has just closed, and vice versa.

It has proven beneficial that a pulse frequency be selected depending on a geometry of the object such that the gas applied at alternating pressure forms a pressure wave in the object, which pressure wave is reflected at an end of the object. Thus, in the interior of the object, one or more superpositions of advancing and returning waves are produced, which superpositions result in local pressure increases and pressure decreases. Furthermore, this also causes pressure increases and pressure pulsations in a direction perpendicular to a direction of travel of the waves or a direction of flow. In this manner, a very effective cleaning can be ensured with a small amount of energy introduced. Typically, a pressure of the applied gas, normally air, is thereby chosen during the pressure pulses such that the air impacts the object at supersonic speed in pulses or intermittently. The pressure pulses can thus be achieved by means of pulsated opening of a valve that connects the nozzle to a corresponding positive-pressure source.

A particularly effective cleaning is achieved when the pulse frequency is selected such that the reflected pressure wave is superposed with an advancing pressure wave at a predefined position in the object in order to attain an improved cleaning effect and/or quality improvement at the predefined position. In a corresponding superposition, a transverse flow that can also penetrate adjacent cell walls normally results in a filter cell from an axial gas movement. Thus, in an automated manner, a very efficient and at the same time effective cleaning and quality improvement can occur if, during the condition measurement that is performed in a first step, not only a degree of a contamination of the object but also a position of the contamination in the object are determined and parameters are derived therefrom for a subsequent cleaning with pulsating compressed air. For example, using optical and/or radiation-based measuring techniques, an accurate position of ash deposits in the particle filter can be detected and parameters matched thereto for a compressed air cleaning can be determined, so that a pressure or velocity of the exiting air and a pulse frequency for a targeted removal of the contanmination in the particle filter can be set. This can also take place in a fully automated manner, especially since a pulse frequency required for a superposition at a predefined position and a velocity of the exiting air result directly from the position predefined by the contamination and from the geometry of the object when known gas-dynamics methods are used. In addition, with an automated detection of the position and type of contamination and faulty areas in the object, it is also possible to make an automated assessment of whether a contamination or faulty areas can still be removed by cleaning or regenerated, respectively. If it is thereby determined that a cleaning is not expedient, the object can also be immediately disposed of without a cleaning being performed.

Particularly for a cleaning by means of a targeted superposition of advancing and returning pressure waves in the object, it is beneficial if a geometry of the object is detected in an automated manner, in particular with an optical sensor such as a camera or a laser scanner. A device for detecting a geometry of the object can be arranged on a cleaning nozzle that can be moved by a Cartesian robot. As an alternative to a Cartesian robot, any installation with which a device can be moved, preferably on multiple axes, in the apparatus can of course be used, for example a polar coordinate robot. In addition, a device of this type can also be positioned stationarily in a corresponding apparatus, wherein the object is moved past the device such that a geometry of the object can be detected. In this manner, a laser scanner or other device for geometry detection, such as a contact bar or a 3D camera, can for example be arranged between a transfer region and a cold cell, so that a geometry can be detected in an automated manner during a movement of the object from the transfer region into the cold cell. Alternatively or additionally, a weight of the object can be measured before, during and/or after a cleaning. From a geometry and/or a weight of the object, a design and shape of the object and of a component size that is to be cleaned can be derived.

On the one hand, damage to the object such as cracks or the like can thereby be detected, so that it is for example possible to determine in an automated manner that a corresponding heavily damaged object no longer needs to be cleaned, but rather discarded. Furthermore, by means of an automated determination of the geometry of the object, it is also possible to calculate which parameters for a compressed air cleaning are necessary to achieve a desired superposition of an advancing pressure wave with a returning pressure wave reflected at an open end of the object.

Additionally, it has proven advantageous if a waste heat of the method is at least partially recovered by a heat exchanger and returned to the process. In this manner, an energy requirement for the method is reduced so that the method can also be decentrally implemented in a cost-efficient manner, for example in motor vehicle repair shops. For example, the waste heat can, via an air preheater, be used to heat a temperature of a supply air for the hot gas cleaning or to increase an ambient temperature in the cold cell to avoid a formation of condensation water during an expansion of compressed air.

According to the invention, the other object is attained by an apparatus of the type named at the outset in which a device for improving a quality of the object and a diagnostic device for measuring a condition of the object as well as a data processing device connected to the diagnostic device are provided, wherein the device for improving a quality of the object can be controlled using the data processing device so that a condition of the object can be determined and a quality improvement carried out in a hilly automated process.

A combined diagnostic and quality improvement apparatus is thus obtained with which a quality of objects such as particle filters, in particular diesel particulate filters, can be improved in a cost-efficient and automated manner, specifically by means of a cleaning. With the data processing system or a logic such as a fuzzy logic implemented in said system, a quality improvement, in particular a cleaning, can take place in a fully automated manner based on a measured condition, and decisions regarding a quality improvement and/or cleaning method can be derived in an automated manner based on measured data so that, for example, the automated cleaning can be performed tailored to an actual cleaning need. This enables a particularly efficient process.

A device for improving a quality of the object can be embodied as a cleaning device. Furthermore, the device for improving a quality can, for example, be set up for applying a coating or a fluid in order to improve or activate a catalytic reactivity of the object. A cleaning device thus in any case constitutes a device for improving a quality of the object, but a device for improving a quality must is not necessarily be embodied as a cleaning device. Of course, multiple devices for the quality improvement can also be provided, wherein one or more devices for the quality improvement can be embodied as cleaning devices, for example for mechanical cleaning using compressed air or thermal cleaning using a hot gas.

Typically, a method for quality improvement, in particular for cleaning, can be performed with the apparatus in accordance with a closed control loop, wherein a quality, in particular a cleanliness condition, is measured as part of a condition measurement and, based on measured data, a quality improvement is carried out, in particular a cleaning, after which the condition is once again measured. With an apparatus according to the invention, a method with a process capability index of more than 1.66 can thus be achieved as a result of an automation of the condition measurement and cleaning or quality improvement. It is beneficial if the apparatus comprises a cold cell for cleaning the object with a positively pressured medium and a hot cleaning cell for cleaning the object with a hot gas. A filter can thus be cleaned with the apparatus both mechanically, for example with compressed air in the cold cell, and thermally, for example with hot air in the hot cleaning cell. In addition, two objects can in principle also be cleaned at the same time through the use of two cells. Of course, multiple cold cells and hot cleaning cells can also be provided.

The hot cleaning cell can be set up for carrying out a thermal cleaning of the object and/or drying the object, for reactivating catalytic centers of the object or the like, in order to improve a quality of the object. Alternatively or additionally, the cold cell can also generally be embodied as a device for quality improvement.

It has proven effective that the apparatus comprises a transport system for a transport of the objects that are to be cleaned with workpiece carriers, wherein the workpiece carriers are gas-permeable. Typically, the workpiece carrier is generally permeable to a fluid such as a liquid or a gas. A particle filter can thus, for example, be transported upright on the workpiece carriers and, at the same type, be cleaned both from a top side and also from a bottom side, for example with compressed air or with a hot gas.

It is advantageous if the workpiece carrier comprises a diffuser with a supply line in order to apply a gas from below over the full area via the supply line to an object positioned on the workpiece carrier. In this manner, objects with a wide range of different sizes can for example be thermally cleaned from both sides and a process gas can flow through and around said objects. With a thermal cleaning of this type of both faces of a particle filter, a complete heating of the filter is also possible with a reduced use of energy compared to an application from only one side. Typically, an application of a hot gas takes place alternatingly from above and below. In this manner, a thermal cleaning from two sides can also take place with a low power consumption or a low connected load. The gas can thereby be air or additives of other gas components, for example, to activate a cleaning effect or to test and clean the object at the same time. The gas can also act as a catalyst and accelerate reactions without being converted.

To adapt the apparatus to objects of a wide range of differing sizes in a particularly simple manner, it is beneficial if the diffuser or a diffuser insert is detachably connected to the workpiece carrier. By means of a simple exchange of the diffuser insert, filters with both large and also small diameters can then be cleaned, wherein the diffuser can be precisely adapted to a filter geometry in each case. For this purpose, the workpiece carrier typically comprises a mount for various diffuser inserts with different geometries, which inserts can thus be modularly connected to the workpiece carriers. Alternatively, the diffuser can also be embodied with a variable geometry in the workpiece carrier.

Advantageously, a radially and/or axially adjustable variable diffuser is positioned in the hot cleaning cell to enable a full-area and uniform application of a hot gas to objects with different diameters. A variable diffuser of this type with a variable geometry can for example be constructionally realized by flat elements, for example metal plates, arranged on a circle or a polygon, wherein the flat elements can be slid into one another so that a design similar to an afterburner jet of supersonic aircraft results. In addition or as an alternative to a variable diffuser, an obliquely adjustable, an axially positionable or axially adjustable adapter with a variable geometry can be provided for adaptation to different objects.

To enable a thermal cleaning with a reduced use of energy, it is advantageous if the apparatus is set up for the simultaneous application of a hot gas to two faces of the object. For this purpose, one device for applying a hot gas from above and, at the same time, one device for applying a hot gas from below can be provided in the hot gas cell. Typically, the device for applying the hot gas from above is embodied as a variable diffuser or as a diffuser with a variable geometry. In addition, a device for measuring a temperature of the object can also be provided in the hot gas cell in order to cool the object as needed. An excessive and object-damaging heating can thus be reliably prevented during a regeneration of carbon black. The apparatus is typically also set up for the interruption of a gas supply and a gas extraction in order to be able to avoid an overheat by interrupting an oxygen supply in the event of an undesired thermal reaction. Alternatively or additionally, it can also be provided that an extinguishing gas or an inert gas is introduced in an automated manner in the event of an overheat. Furthermore, an automatic emergency shutdown and cooling of the apparatus can also be provided in case of an overheat.

It has proven effective that, in the cold cell, a mechanical cleaning device is provided for cleaning the object with a gas at a pulsating alternating pressure of preferably 0.1 Hz to 100 Hz, in particular 1 Hz to 10 Hz. It has been shown that, by means of a pulsating application of compressed air, contamination in the object can be cleaned particularly well, for example ash and the like.

Furthermore, it has proven advantageous that the device comprises multiple, in particular two to five, nozzles. In this manner, depending on the alignment of the nozzles, either a simultaneous cleaning over an even larger area is possible or, if the nozzles are aimed at the same position of the object, a cleaning with compressed air at a correspondingly increased frequency is possible. Normally, the nozzles are actuated alternatingly so that one compressor or one other gas generator with a low power consumption is sufficient to supply the compressed air.

To ensure an efficient and, at the same time, effective automated removal of contamination, it has proven beneficial if the apparatus is set up for determining a pulse frequency at which a pressure wave reflected at an end of the object is superposed with an advancing pressure wave at a predefined position in the object in order to achieve an improved cleaning effect at the predefined position. For this purpose, the apparatus is normally set up with a device for detecting a geometry of the object as well as a data processing device, wherein with the data processing device, required characteristics of applied pressure pulses, that is in particular frequency, pressure, velocity and sequence of the pressure pulses, can be calculated by application of fluid-mechanics or gas-dynamics methods based on the geometry of the object in order to achieve a corresponding superposition in the object.

For the targeted removal of contamination in the object, it is furthermore advantageous if the apparatus is set up for determining local contamination in the object, for example, using an optical measuring technique or through an analysis of the object by means of radiation, for example X-ray radiation.

An effective cleaning or contamination removal in the object can be achieved in a particularly advantageous manner with compressed air if the mechanical cleaning device is set up for applying compressed air at 1.5 times to 2.5 times the speed of sound. Normally, compressed air is applied at approximately 1.9 times the speed of sound. In this manner, effects of advancing waves and returning waves reflected at an end of the object can also be exploited particularly well for cleaning.

### BRIEF DESCRIPTION OF THE DRAWINGS

Additional features, benefits and effects of the invention follow from the exemplary embodiment described below. The drawings which are thereby referenced show the following:

FIG. 1 An apparatus according to the invention in a side view;

FIG. 2 A detailed illustration of an apparatus according to the invention;

FIG. 3 through 5 A workpiece carrier of an apparatus according to the invention;

FIG. 6 An additional detailed illustration of an apparatus according to the invention.

### DETAILED DESCRIPTION OF THE EMBODIMENTS

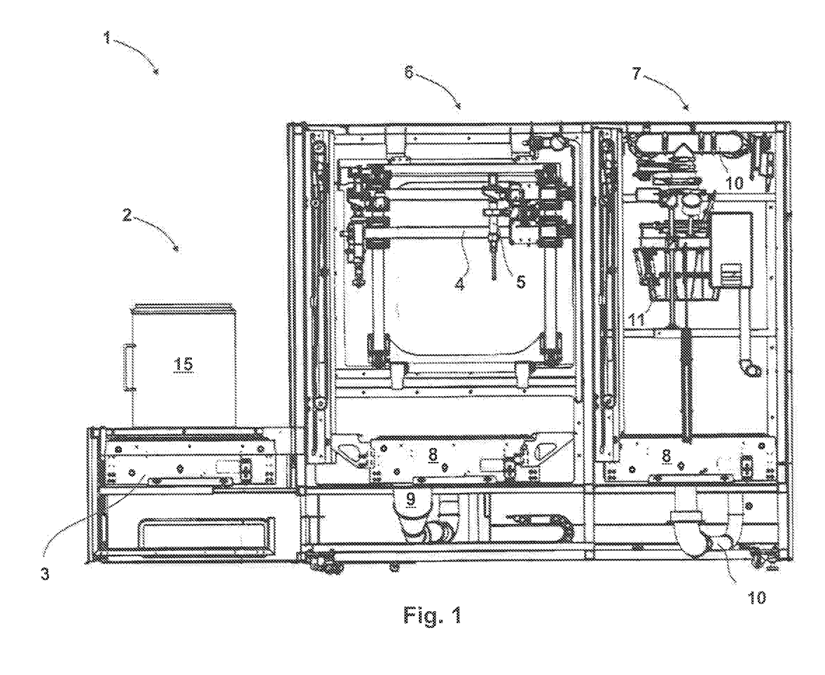

FIG. 1 shows in a side view an apparatus 1 according to the invention for the cleaning and quality improvement of an object, such as a filter 15 or catalyst, removed from an exhaust gas system of an internal combustion engine, wherein a side cover is not illustrated. The apparatus 1 according to the invention and the method according to the invention are explained below in reference to a filter 15, even though an implementation with other gas-permeable objects is also possible.

The apparatus 1 comprises a transfer region 2, a cold cell 6 and a hermetically sealed hot cleaning cell 7. To carry out the method according to the invention, a filter 15 that is to be cleaned is positioned in the transfer region 2 on a workpiece carrier 3. In a fully automatic manner, the filter 15 is then transported into the cold cell 6 for condition measurement and cleaning and subsequently into the hot gas cell and finally back to the transfer position. During an entry of the filter 15 into the cold cell 6, a filter geometry is scanned by a stationarily positioned laser scanner, so that devices in the cold cell 6 and the hot gas cell can be adapted to a filter geometry and, if necessary, any interfering contours present.

For a transport of the workpiece carrier 3 and a filter 15, a chain drive or a heavy-duty guide based on a drawer principle can be provided. Typically, the workpiece carriers 3 are connected via positive-fit connections to a conveyor system 8 and conveyed through the apparatus 1, wherein positioning aids can also be provided for a central and location-oriented position of the filters 15 and catalysts. For an automatic processing of multiple components, a workpiece buffer can also be provided in the workpiece feed, from which buffer one part after another can automatically be fed. After a cleaning, the cleaned parts can be stored in a finished part buffer.

In the cold cell 6, a device for detecting a condition of the filter 15 or a diagnostic device is provided, for example a device for testing a differential pressure of the filter 15 or a camera for optical analysis, a laser scanner or the like. Of course, devices for the condition measurement can in principle be provided both in the cold cell 6 and also in the hot cleaning cell 7. Based on a condition of the filter 15 measured with the diagnostic device, a decision is then made in an automated manner about a cleaning that is to be performed or parameters for a cold cleaning or hot cleaning. For an automated decision, empirical values from previously performed cleanings can also be used as a resource by a decision logic in a data processing system. The apparatus 1 can thus also be embodied as a self-learning apparatus 1 so that an efficiency of the method is constantly improved with an increasing number of cleanings performed. A decision is thereby made in an automated manner about a necessary cleaning depending on a measured quality or a condition of the filter 15, or a cleaning strategy is determined and implemented independently of an operator.

Furthermore, a device embodied as a mechanical cleaning device 5 for improving a quality of the object is provided in the cold cell 6 to enable a compressed air cleaning of the filter 15. This device can comprise one or more nozzles 19 with which compressed air can be applied to the filter 15 at an air discharge velocity of, for example, Mach 1.91 and with a narrow spray angle.

Typically, in the mechanical cleaning device 5, two to five nozzles 19 are provided which are simultaneously supplied with a flow or pulsated in a time-staggered manner, for example via a piston shuttle valve. In this manner, the application of pressure waves to the filter 15 is possible, which waves are reflected at a bottom end of the filter 15 or an open end. Thus, as a result of a superposition of advancing and returning waves in the filter 15, a pressure increase occurs at pre-calculable positions, so that a removal can take place in a targeted manner at defined positions. In addition, it has been shown that a superposition of advancing and returning waves in the filter 15 also causes a pressure increase or pressure pulsations perpendicular to a stream direction, that is, roughly in a horizontal direction in the exemplary embodiment. This also leads to a cleaning effect in adjacent cells of a particle filter with a honeycomb structure, even if compressed air is not directly applied to these adjacent cells.

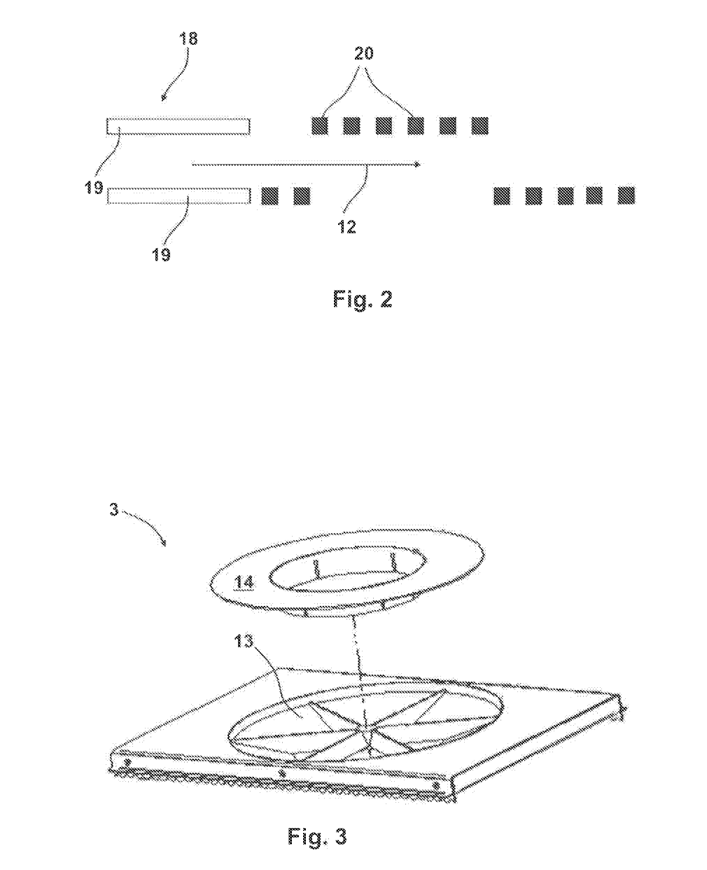

A possible embodiment of a mechanical cleaning device 5 of this type is illustrated in FIG. 2, wherein regions with different pressures are also visualized as in a schlieren image. The mechanical cleaning device 5 is thereby embodied as a duplex nozzle 18 having two nozzles 19. The nozzles 19 are set up to apply supersonic pressure pulses 20 at a frequency of 1 Hz to 10 Hz and are typically actuated such that compressed air is applied in a pulsated manner by one nozzle 19 while the other nozzle 19 is closed. An opening and closing of the nozzles 19 is thereby possible very rapidly or with steep edges, so that pressure curves over time have a rectangular shape and a large flow velocity gradient as well as a strong impulse can be generated. This results in pressure pulses 20 advancing along a direction of flow 12 at a supersonic velocity with a very narrow spray angle. The pressure pulses 20 emitted by the respective nozzles 19 thereby move along streamlines of the nozzles 19 which, starting at each nozzle 19, extend in the direction of flow 12 and are thus also roughly parallel and typically have a distance between them of only a few centimeters, in particular a few millimeters.

In the mechanical cleaning device 5 illustrated in FIG. 2, six pressure pulses 20 each are applied or emitted by one nozzle 19, after which this nozzle 19 is closed and six pulses are applied by the respective other nozzle 19. In a region of the pressure pulses 20 or the advancing air, a static pressure on the respective streamline is significantly lower than in a region in which no pressure pulse 20 is advancing or in which the air is still. The pulsating actuation of the nozzles 19 thus causes not only a pulsating application of air in the direction of flow 12, but also correspondingly propagating pressure fluctuations in the direction of flow 12. Since the nozzles 19 are actuated alternatingly and a distance between the nozzles 19 in roughly parallel alignment is very small, this results in a strong pressure gradient perpendicular to the direction of flow 12 between a pressure pulse 20 and a region in which there is no pressure pulse 20, or between the streamlines of the two nozzles 19, so that a pulsating flow gradient transverse to the direction of flow 12 is produced. This pulsating flow gradient transverse to the direction of flow 12 causes a spatial pulsation field or spatially propagating pressure fluctuations which, together with interference effects, enable an increased cleaning effect.

In the filter 15, the pressure differences in the direction of flow 12 and perpendicular to the direction of flow 12 result in an improved removal of soot and dust from interior filter walls. Another advantage of this cleaning method is that, through the pulsating application of compressed air, less compressed air is required for cleaning than in a continuous application of compressed air. Furthermore, an application of force to the filter 15 is less than with a continuous application of pressure, as a consequence of which damage to the filter 15 is avoided.

The device for compressed air cleaning of the filter 15 is normally set up to apply compressed air to a small section of a face of the filter 15. In order to still be able to fully clean the filter 15, a Cartesian robot 4 is usually also provided for the variable positioning of the device in all spatial directions relative to the filter 15 in the cold cell 6.

Typically, a diagnostic device for the condition measurement of the filter 15 is also positioned relative to the filter 15 by the Cartesian robot 4 in order to assess a quality of individual sections of the filter 15, for example optically, with a differential pressure test, by measuring a degree of blackening, or by measuring a particle capture rate or a particle retention capacity. A particle retention capacity is typically determined in that, by means of a particle generator, a particle-containing gas is generated that is applied to the filter, after which particles transported through the filter are measured at a position located downstream. The mechanical cleaning device 5 can thereby also be embodied as a combined cleaning and diagnostic device, for example, with a diagnostic and cleaning nozzle or a combination nozzle for applying compressed air for the cleaning and for the differential pressure test and/or for the application of a reactive gas to assess a catalytic reactivity. Furthermore, a camera for the optical assessment of the filter 15 can be provided in or on the combination nozzle. In addition, a hot gas for regeneration and for cleaning can also be applied by means of the combination nozzle.

Normally, a condition of the filter 15, in particular a differential pressure, is measured at approximately 50 positions on a particle filter, so that heavily contaminated regions or regions with inadequate quality can be identified and subsequently cleaned in a targeted manner in order to improve a quality of said regions.

Furthermore, a device for moving the workpiece carrier 3 in the cold cell 6 can be provided to reach a desired position of the diagnostic device or cleaning nozzle relative to the filter 15. For example, a diagnostic or cleaning nozzle can be translationally movable in three spatial directions and the workpiece carrier 3 rotationally movable in one or more spatial directions, in order to achieve a suitable relative positionability of the filter 15 and combination nozzle with a constructionally simple design, and thus to achieve a suitable cleaning effect.

Furthermore, a measurement of a catalytic reactivity can occur in sections, for example in that an NO/NO2 conversion is detected by means of an application of nitrogen monoxide to the filter 15 and a subsequent measurement of nitrogen dioxide at a position located downstream below the filter 15. In addition, a measurement of a CO/CO2 conversion, a conversion of HC gas into CO and CO2 and H2O and the like can of course also be provided for the quality measurement. Furthermore, a formation of ammonia gas in SCR catalysts and a conversion of ammonia and nitrogen oxides into nitrogen and CO2 and the like can also be detected, preferably also in sections.

At a position below a conveyor system 8 for the workpiece carrier 3, an extraction line 9 is arranged in the cold cell 6 to collect, remove and dispose of soot cleaned off of the filter 15. For this purpose, a dust separator, in particular a cyclone separator, can be provided.

Based on a measured quality of the filter 15, parameters for a necessary cleaning, for example a duration of a mechanical cleaning or a temperature of a thermal cleaning in the hot gas cell, are then selected in an automated manner, after which a possibly necessary mechanical cleaning is performed in the cold cell 6. Based on measured data, a comparison with a reference component can also be carried out, and the filter can be evaluated as being good or bad based on the comparison.

Adjoining the cold cell 6 is the hot cleaning cell 7 for improving a quality of the filter through a thermal cleaning in the apparatus 1, which hot cleaning cell 7 is separated from the cold cell 6 by an automatic and sealing door. In this manner, a hermetic separation of an interior of the hot cleaning cell 7 from the cold cell 6 and a surrounding environment is achieved, so that an escape of hot air during a hot cleaning is prevented and, if necessary, an inflow of oxygen can be interrupted in the event of an undesired thermal reaction. Furthermore, a variable diffuser 11 with a variable geometry in radial and axial directions is provided at the head end in the hot cleaning cell 7. The variable diffuser 11 can thus be adapted to filters 15 with different diameters in a simple and automated manner. For example, the illustrated apparatus 1 is suitable for filters 15 with substrate sizes of 4¾ inches to 15 inches. The variable diffuser 11, which can be adapted both to round and also to rectangular faces of filters, is connected to a hot gas supply line 10, so that a hot gas such as air can be applied to the filter 15 for cleaning through the variable diffuser 11. Furthermore, the hot gas supply line 10 also opens into a region below a conveyor system 8 for the workpiece carrier 3 so that, in the hot cleaning cell 7, an application to the filter 15 is possible both from above through variable diffuser 11 having a variable geometry and also from below through a gas-permeable workpiece carrier 3 having a diffuser insert 14. A hot gas can be created centrally using a heater. Alternatively, one heater each, for example an electrically powered heater, can be provided at the bottom end and head end in the hot gas cell.

An exhaust air from the hot gas cell is conducted via a heat exchanger that is not illustrated, in order to recover an energy from the hot gas after the cleaning, for example to preheat a hot gas before cleaning. A residual heat or an exergy present can be removed from the cold cell with the exhaust air and from the system with a scavenging air.

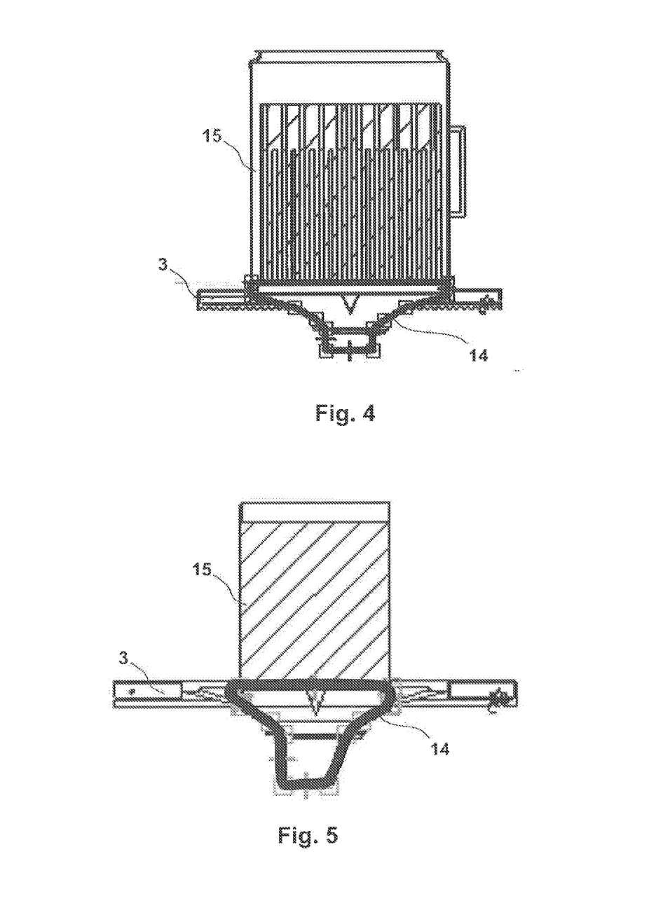

FIG. 3 shows a workpiece carrier 3 with a diffuser insert 14 in an exploded view. As can be seen, the workpiece carrier 3 comprises a central opening 13 in which a diffuser insert 14 is arranged. This also enables a full-area and uniform application of gas to a bottom face of the filter 15, which face is connected to the workpiece carrier 3.

FIGS. 4 and 5 show sections through workpiece carriers 3 of apparatuses 1 according to the invention, in which carriers different diffuser inserts 14 are arranged with filters 15 of a different size. As can be seen, because of the detachable connection of diffuser inserts 14 of a different size to workpiece carriers 3, the same workpiece carrier 3 can be easily adapted for a wide range of different filter geometries or diameters through an exchange of corresponding diffuser inserts 14. It is thus ensured that, even with filters 15 of a different size, an entire volumetric flow of a hot gas is conducted into the filter 15 during a hot gas cleaning, so that a high energy efficiency is achieved, which particularly for a use of the apparatus 1 in small motor vehicle repair shops is advantageous.

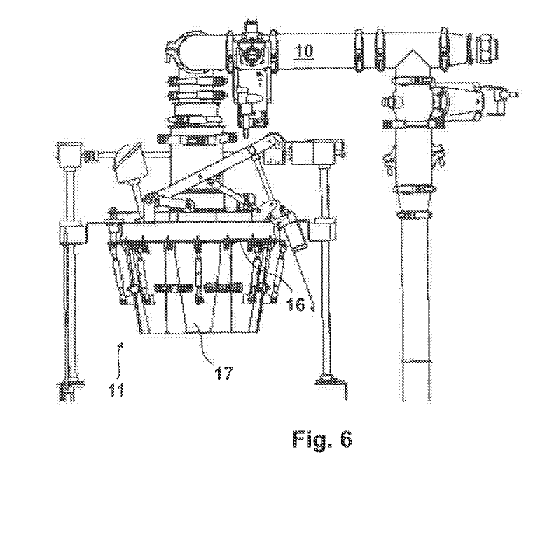

FIG. 6 shows in detail the variable diffuser 11 of the hot gas cell of the apparatus 1 according to the invention. The variable geometry of the variable diffuser 11 is thereby achieved by flat or plate-shaped elements 17 that can be slid into one another, in this case thin, approximately tapered and/or flexible metal plates, which are arranged along a circular contour 16 at an upper end such that they can be moved or pivoted about an axis tangential to the circular contour 16. During a cleaning, a center point of a circle of the contour 16 is positioned roughly on an imaginary longitudinal axis of a filter 15 located in the hot gas cell. A plane of the circle lies roughly perpendicular to the imaginary longitudinal axis and perpendicular to an image plane in FIG. 6.

By means of the correspondingly movable arrangement of plate-shaped, preferably heat-resistant, elements 17, a sliding-into-one-another of the metal plates, and thus a variation of an effective diameter, is possible at a lower end of the variable diffuser 11, similar to an afterburner jet on a supersonic aircraft. A hot gas supply line 10 is connected to the variable diffuser 11, so that a filter 15 positioned on a workpiece carrier 3 in the hot gas cell can be cleaned both from above and also from below with a hot gas at a temperature of typically 200° C. to 900° C. This results in a particularly efficient cleaning, as an energy necessary for the cleaning can be reduced by the dual-sided application of a hot gas. In order to be able to operate the system with a low connected load, a cleaning from above normally takes place alternatingly with a cleaning from below, even though a simultaneous cleaning from above and below is also possible in principle.

Typically, a condition of the filter 15 after a cleaning with compressed air and a cleaning with a hot gas is measured again in an automated manner to determine a cleanliness condition. A decision can then be made in a data processing device in an automated manner about whether a new and, if necessary, which cleaning is required, or whether a cleaning is complete. If the cleaning is complete, the filter 15 is transported to the transfer position with the workpiece carrier 3 by means of the conveyor system 8, at which position the filter 15 can be removed. Finally, a paper printout regarding a completed cleaning and an attained cleanliness condition can also be created to document a completed cleaning. Based on the cleanliness condition attained, an expected remaining service life can thereby be calculated and outputted.

All method steps between the delivery of the filter 15 at the transfer position and the removal of the filter 15 take place in an automated manner, so that no manual intervention is required. Although only one filter 15 is illustrated in the apparatus 1 in the exemplary embodiment, an embodiment of the apparatus 1 with an integrated buffer storage for additional filters 15 is also possible, so that multiple filters 15 can be delivered simultaneously and can be measured and cleaned or reprocessed in the apparatus 1.

With an apparatus 1 according to the invention and a corresponding method, a fully automated cleaning of a soiled object such as a filter 15 or catalyst is possible in a particularly energy-efficient manner. The corresponding apparatus 1 can be operated at low electric power and, at the same time, can be produced in a very compact and cost-effective manner. For example, through a sequential measurement and cleaning in the cold cell 6 on the one hand and subsequently in the hot gas cell on the other hand, a connected load of the apparatus 1 of only 13 kW can be achieved, even though a total of the wattage ratings of energy consumers in the apparatus 1 can be 20 kW and higher. Furthermore, the apparatus 1 from the exemplary embodiment is set up for the exclusive dry cleaning of the filter 15, so that no liquids need to be stocked, cleaned or disposed of. The apparatus 1 can thus be embodied to have a small installation space and to be very compact, as a result of which the apparatus can be transported through typical repair shop doors with a width of 0.8 m and a height of 1.8 m and can be operated with little effort. Typically, all process materials, temperatures, pressures, movements and the like necessary for the method are supplied by the apparatus, so that only a power connection is required to operate the apparatus.

The apparatus 1 is therefore well suited for a decentralized use, for example in motor vehicle repair shops. A compressor necessary for the supply of compressed air in the apparatus 1 can thereby also be used to supply compressed air in the motor vehicle repair shop. In addition, a waste heat from the hot gas cell can also be reused to further reduce an energy requirement.

What is claimed:

1. A method for the quality improvement of a gas-permeable object, such as a filter (15) or catalyst, removed from an exhaust gas system of an internal combustion engine, characterized in that in an automated process, a condition of the object is measured, after which a quality improvement is carried out, after which a condition of the object is measured again.

2. The method according to claim 1, characterized in that the object is transported during the process with a workpiece carrier (3) that is gas-permeable and, in particular, comprises a diffuser.

3. The method according to claim 1, characterized in that the object is cleaned with a hot gas that is applied through an axially and/or radially adjustable variable diffuser (11) which is adapted to a geometry of the object before application of the hot gas.

4. The method according to claim 1, characterized in that a hot gas is applied to two opposing faces of the object from different directions.

5. The method according to claim 1, characterized in that a cleaning takes place with a pressurized gas, preferably air, which is applied at a velocity of 1.0 to 3 times the speed of sound.

6. The method according to claim 5, characterized in that the gas is applied through a nozzle (19), wherein a spray angle is 1° to 45°, preferably 10° to 15°.

7. The method according to claim 1, characterized in that, for the cleaning, a gas is applied alternatingly to a face of the object through multiple, in particular two to five, nozzles (19).

8. The method according to claim 5, characterized in that the gas is applied with time-variable pressure or in pulses, preferably at a frequency of 0.1 Hz to 100 Hz, in particular 1 Hz to 10 Hz, wherein preferably multiple, in particular two to live, nozzles (19) are used and pressure pulses (20) are applied through the individual nozzles (19) in a time-staggered manner.

9. The method according to claim 8, characterized in that a pulse frequency is selected depending on a geometry of the object such that the gas applied at alternating pressure forms a pressure wave in the object, which pressure wave is reflected at an end of the object, wherein preferably the pulse frequency is selected such that the reflected pressure wave is superposed with an advancing pressure wave in the object at a predefined position in order to attain an improved cleaning effect at the predefined position.

10. An apparatus (1) for the diagnosing and quality improvement of a gas-permeable object, such as a filter (15) or a catalyst, removed from an exhaust gas system of an internal combustion engine, in particular for performing a method according to claim 1, characterized in that a device for improving a quality of the object and a diagnostic device for measuring a condition of the object as well as a data processing device connected to the diagnostic device are provided, wherein the device for improving a quality of the object can be controlled using the data processing device so that a condition of the object can be determined and a quality improvement carried out in a fully automated process.

11. The apparatus (1) according to claim 10, characterized in that the apparatus (1) comprises a transport system for a transport of the objects that are to be cleaned with workpiece carriers (3), wherein the workpiece carriers (3) are gas-permeable, wherein preferably the workpiece carrier (3) comprises a diffuser insert (14) in order to apply a gas from below over the full area via the supply line to an object positioned on the workpiece carrier (3), wherein the diffuser insert (14) is preferably detachably connected to the workpiece carrier (3).

12. The apparatus (1) according to claim 10, characterized in that the apparatus (1) comprises a hot cleaning cell (7) for a thermal cleaning of the object, wherein a radially and/or axially adjustable variable diffuser (11) is positioned in the hot cleaning cell (7) to enable a full-area and uniform application of a hot gas to objects with different diameters.

13. The apparatus (1) according to claim 10, characterized in that the apparatus (1) comprises a cold cell (6), and that in the cold cell (6), a mechanical cleaning device (5) is provided for cleaning the object with a gas at a pulsating alternating pressure of preferably 0.1 Hz to 100 Hz, in particular 1 Hz to 10 Hz, wherein the device comprises multiple, in particular two to five, nozzles (19).

14. The apparatus (1) according to claim 13, characterized in that the apparatus (1) is set up for determining a pulse frequency at which a pressure wave reflected at an end of the object is superposed with an advancing pressure wave at a predefined position in the object to achieve an improved cleaning effect at the predefined position.
